(19) United States
(12) Patent Application Publication
(10) Pub. No.: US 2004/0138974 A1
(43) Pub. Date: Jul. 15, 2004

(54) Method and system for managing money of a customer

(76) Inventors: Atsushi Shimamura, Yokohama (JP); Toshiyuki Moritsu, Kawasaki (JP); Daisuke Yoshimine, Rumoi (JP); Kunihito Takeuchi, Zushi (JP)

Correspondence Address: MCDERMOTT WILL & EMERY, 600 13TH STREET, N.W., WASHINGTON, DC, 20005-3096, US

(21) Appl. No.: 10/642,520

(22) Filed: Aug. 18, 2003

(30) Foreign Application Priority Data
Dec. 27, 2002 (JP) 2002-378946

(51) Int. Cl. G06F 17/60

(52) U.S. Cl. 705/35

(57) ABSTRACT

If money is paid in from a customer, an outstanding amount of a real account of the customer in each of financial institutions is identified, to calculate a shortage between the outstanding amount and a predetermined amount. Whether the money amount paid in from the customer exceeds the shortage is decided and, if the pay-in money amount does not exceed the shortage, the pay-in money amount is determined to be a pay-in money amount for the real account, to perform pay-in processing. If the pay-in money amount exceeds the shortage, the shortage is determined to be a pay-in money amount for the real account. Then, almost the same arithmetic operations are repeated on real accounts other than the real account for which the pay-in money amount has been determined, to determine a pay-in money amount for the real accounts other than that real account, thus performing pay-in processing.

### BACKGROUND OF THE INVENTION

The present invention relates to system and a method for money settlement work in a financial institution, and more particularly, to method and system for distributing money of a customer deposited into one financial institution to a plurality of financial institutions and depositing it into them.

An enterprise and an individual open their accounts in a financial institution as a customer thereof, to transact business of paying or receiving deposit money, etc. “Pay-off” refers to a system by which, if a financial institution has crashed, it secures only to pay a certain amount of a total sum of deposited money amounts for each customer. The customer is not secured in payment of his/her deposited money in excess of the certain amount (as of April 2002 in Japan, a checkable deposit is secured in payment in full but the other fixed-period deposits are secured in payment of only up to 10 million yen of an original principal and its interest). An amount of money in excess or that certain amount is paid according to a situation of remaining finances of the crashed financial institution, thus destroying a conventional concept that deposits are secured. To cope with this “pay-off” system, the enterprise and the individual can distribute their money over a plurality of financial institutions and deposit it therein safely. To deposit a large amount of money safely, however, a customer needs to transact business with many financial institutions individually, which is a heavy burden on him/her. To solve this problem, some financial institutions have started a service to accept, at a counter in one of them, a request for depositing money in a plurality of other financial institutions, in which case the customer need not actually come up to the plurality of financial institutions.

EP-A-1081628 (corresponding to JP-A-11-259588) discloses a method for linking money of a customer with accounts of a plurality of financial institutions by using an information system, in which method a customer account is determined to which the money is to be transferred based on an interest rate etc. of the financial institutions.

JP-A-2002-157631 discloses an approach for opening a virtual account which is subject to a request for a transaction and dedicated to the transaction and at least one deposit account 20 which is subject to an actual transaction and also correlating the virtual account and the at least one deposit account with each other so that, upon reception of a transaction request for the virtual account, the transaction request for the virtual account may be transferred into a transaction request for the at least one deposit account thus correlated.

JP-A-2001-243400 discloses an approach for storing account information of a related account linked with a plurality of user accounts, to use the related account as an account contracted for a transaction, thus transmitting money information from the related account to one of the plurality of user accounts.

JP-A-09-326002 discloses a method for establishing a virtual bank in a network as against a real bank for paying a price of a purchased commodity, which virtual bank has a virtual account of a utilizer and a virtual account of each of sales outlets, so that when the utilizer has purchased a commodity, the virtual bank transfers money between the virtual bank of the utilizer and the virtual bank of the sales outlet and also gives a real bank an instruction for automatic transfer for payment of a price, based on which instruction the real bank settles the price.

Conventionally, even when depositing money from a counter of one financial institution into another financial institution, it means only that the former financial institution performs counter work for the latter financial institution, so that a customer has had to instruct pay-in to each of the financial institutions individually. Further, even when managing a plurality of accounts of a customer by using an information system, it does not aim at protection of money from “pay-off”, so that the money cannot securely be protected if it takes long time to follow a payment procedure at a relevant financial institution or the financial institution may crash halfway the procedure.

### SUMMARY OF THE INVENTION

It is an object of the present invention to provide a method and a system for suppressing a risk of a customer suffering damages due to crashing of a financial institution.

By the present invention, money paid in by a customer is distributed over to a plurality of financial institutions so that an outstanding amount in each of the financial institutions may not exceed a predetermined amount.

Specifically, when money is paid in by a customer, an outstanding amount in a real account of the customer in each of the financial institutions is identified, to calculate a shortage of the outstanding amount with respect to a preset amount (for example, a deposited amount to be protected at the time of crashing of the financial institutions or a distribution money amount limit preset for each of the financial institutions). Whether the money amount paid in by the customer exceeds the shortage is decided and, if such is not the case, the paid-in money amount is determined to be a money amount to be paid into the real account, to perform pay-in processing. If the paid-in money amount exceeds the shortage, the shortage is determined to be a money amount to be paid in, to then repeat the same operations on real accounts other than that real account determined to receive that money amount so that a pay-in money amount may be determined for those real accounts other than that real account, thus performing the pay-in processing.

Further, a virtual account may be opened in each of financial institutions for each of customers and linked with a real account in each of the financial institutions so that, when money is paid by any one of the customers into the virtual account, a money amount to be paid into each real account of the customer can be determined, to transfer money from the virtual account to the real account.

Further, a common account may be opened in a financial institution so that money, if paid into a virtual account by a customer, can be once transferred into the common account to then determine a money amount to be paid into each of real accounts possessed by the customer and transfer the money from the common account to the real accounts.

Here, a real account refers to an account in the name of a customer for the purpose of retaining his/her money. A virtual account refers to an account in the name of a customer for the purpose of retaining his/her money temporarily. Therefore, an outstanding amount is zero ordinarily; however, if a customer requests pay-in or pay-out of money, the outstanding amount becomes a pay-in or pay-out money amount. A common account refers to an account having no name of a customer or in the name of a financial institution for the purpose of retaining money of the customer temporarily. The common account is capable of retaining money of customers.

By the present invention, a possibility can be reduced that an outstanding amount of a customer in each of financial institutions exceeds a preset amount, thereby suppressing a risk that he/she may lose his/her money in excess of a predetermined amount if any one of the financial institutions crashes.

Further, by the present invention, money of a customer is not concentrated to a particular financial institution, so that a risk can be suppressed that he/she may lose a large amount of his/her money if the particular financial institution crashes. That is, if a particular financial institution crashes, a customer, who possesses money also in other financial institutions, is less likely to lose all of the money. This is effective also in a case where money of a customer is not protected at all when a financial institution has crashed.

Other objects, features and advantages of the invention will become apparent from the following description of the embodiments of the invention taken in conjunction with the accompanying drawings.

### BRIEF DESCRIPTION OF THE DRAWINGS

FIG. 1 is an overall illustration for showing the present invention;

FIG. 2 shows a customer information table managed by money management system by referencing a customer information DB;

FIG. 3 shows a flowchart of paying money into an account according to the present invention;

FIG. 4 shows a flowchart of collecting money from accounts according to the present invention;

FIG. 5 shows a method for selecting an account in order to reduce cost due to inter-financial institution settlement; and

FIG. 6 shows a method for outputting particulars of a transaction performed by a customer.

### DETAILED DESCRIPTION OF THE EMBODIMENTS

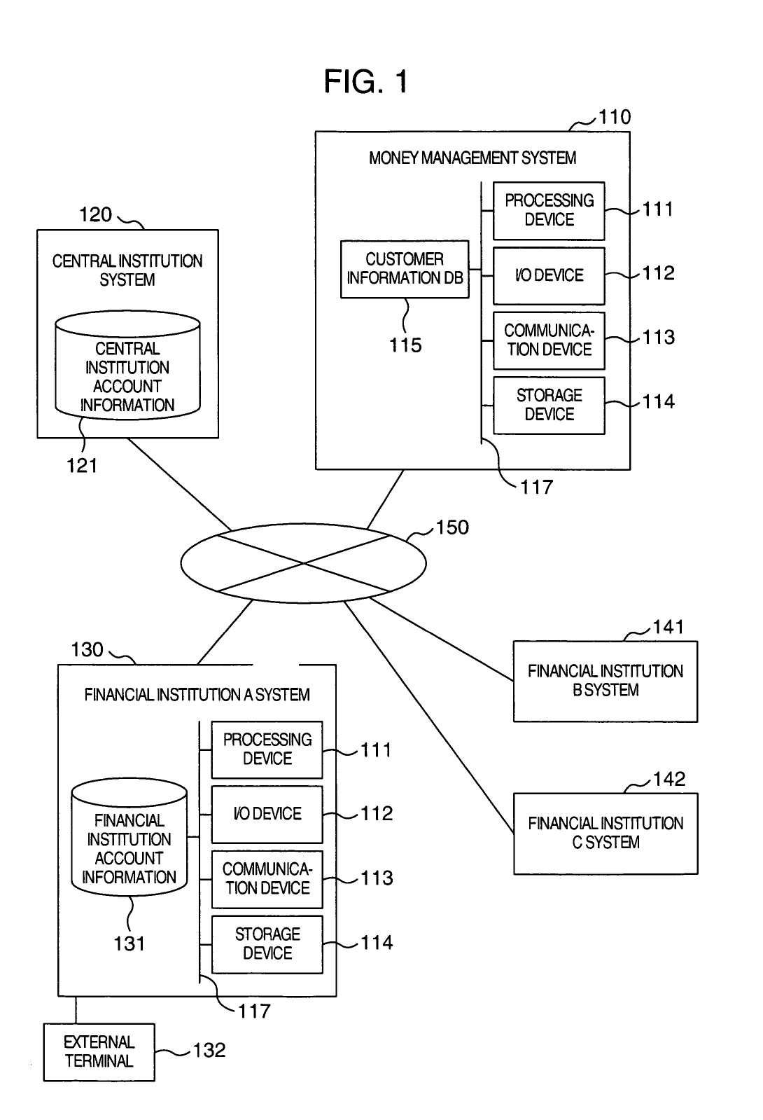

Embodiments of the present invention provide a method for realizing a service that is provided to each of customers by a plurality of financial institutions. FIG. 1 shows a configuration illustration of an overall system related to the present invention. The embodiment of the present invention uses such a configuration that a money management system 110, a central institution system 120, a financial institution A system 130, a financial institution B system 141, and a financial institution C system 142 are connected mutually by a network system 150. In this configuration, the money management system 110 is provided to manage transfer of money of a customer. The money management system 110 may be installed either independently or in any one of the financial institutions. The money management system 110 mutually connects a processing device 111, an input/output device 112, a communication device 113, a storage device 114, and customer information DB115 through an internal communication path 117, being constituted of, for example, a main frame, a workstation, or a personal computer. The processing device 111 is, for example, a processor for executing a program stored in the storage device 114 in order to control operations of the money management system 110. The input/output device 112 is provided for operations by an operator, being constituted of, for example, a keyboard and a display. The communication device 113 is provided for the money management system 110 to communicate with an external system, being constituted of, for example, an LAN adaptor or a MODEM. The storage device 114 is constituted of, for example, a memory or a hard disk, storing a program required for the processing device to operate or data required for the program to execute processing. The customer information DB115 is a DB (database) provided to manage information of customers, details of which are described later. The internal communication path 117 is provided to mutually connect the functional devices, being constituted of a bus, for example. Hereinafter, it is supposed that, in operation of the money management system 110, the program stored in the storage device 114 is executed by the processing device 111.

The central institution system 120 is installed in a financial institution, to hold central institution account information 121. In the present embodiment, although the central institution system 120 may be installed in an ordinary financial institution, preferably it is installed in such a financial institution as to have a low risk of crashing as compared to other financial institutions (for example, Bank of Japan or shinkin central bank in the shinkin bank business circle) and to be especially safe. The central institution account information 121, typically referred to as an accounting-based system, is a system for managing accounts in a financial institution. In the present embodiment of the present invention, a common account for all of customers participating in the present service is opened in the central institution account information 121. The common account is provided to temporarily retain money deposited from all of customers participating in the present service and need not necessarily be in the name of each participant customer in order to be easily managed. The common account is not put in the name of the individuals but shared by all of the participant customers, so that shares of the individual customers in the common account are managed by the money management system 110 in the customer information DB115 (details of which are described later).

The financial institution A system 130 is installed in an ordinary financial institution (which is supposed to be financial institution A). The financial institution A system 130 mutually connects the processing device 111, the input/output device 112, the communication device 113, and the storage device 114 through the internal communication path 117 as in the case of the financial institution system 110, as well as account information 131 and an external terminal 132. Similar to the central institution account information 121, financial institution account information 131 is an accounting-based system of a financial institution, for managing an outstanding amount of a deposit in each account. The external terminal 132 is a terminal or an ATM installed at a business office or an office center of a financial institution, a terminal (PC etc.) of a customer connected via the Internet to the financial institution, or a terminal (dedicated terminal, PC, stationary type telephone, portable telephone, etc.) of a customer connected via any other public circuit to the financial institution, constituting a device for receiving a request for pay-in or pay-out of money from a customer at a financial institution, registering customer information, permitting the customer to pay in his/her own money or pay it out, or displaying particulars of a transaction performed by the customer.

The financial institution B system 141 and the financial institution C system 142 each have a configuration similar to that of the financial institution A system 130. In the present embodiment, many financial institutions present are represented by the financial institutions A, B, and C, while systems installed in these financial institutions are represented by the financial institution A system 130, the financial institution B system 141, and the financial institution C system 142. Further, although each customer of one person (or one corporation) directly makes a transaction with different financial institutions according to whether they are a single or more than one, the following will make description assuming that the customer mainly transacts business with the financial institution A. Hereinafter, operations of the financial institution A system 130, the financial institution B system 141, and the financial institution C system 142 are supposed to be processed by the processing device 111 when it executes a program recorded in the storage device 114. The network 150 is a communication path for connecting a variety of systems, coming in a network or the Internet for mutually connecting financial institutions.

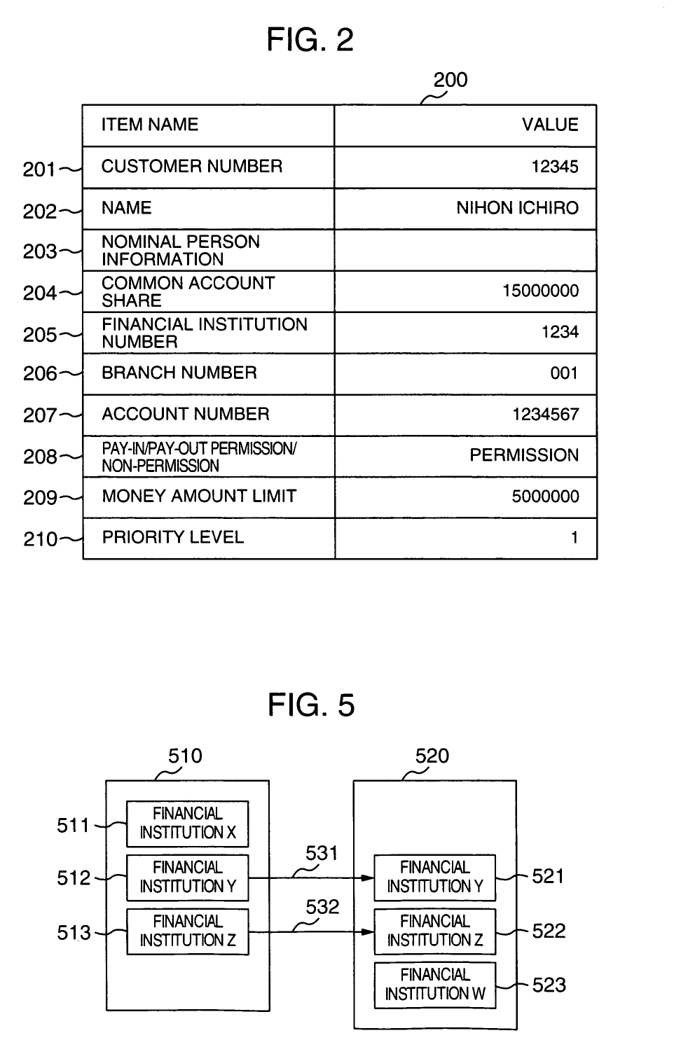

The following will describe a configuration of the customer information DB115 with reference to FIG. 2. The customer information DB115 manages a customer information table 200 shown in FIG. 2 for each customer. The customer information DB115 holds the customer information table 200 for every customer. For each customer, the customer information table 200 holds a customer number 201, a name 202, nominal person information 203, a common account share 204, a financial institution number 205, a branch number 206, an account number 207, a pay-in/pay-out permission/non-permission 208, a money amount limit 209, and a priority level 210. Of these, the customer number 201 is used to identify a customer uniquely. The name 202 refers to a customer's name or a business name etc. The nominal person information 203 refers to reading of a name, a customer's birth date, an address, a representative's name, a birth date of the representative, etc. in the case of a corporation, and information (for example, a number for identifying an identification paper (driver's license, passport, insurance certificate, etc.) or image data of the identification paper picked up with a scanner) used by a financial institution in identification at the time of conclusion of a contract of deposit etc. for account opening etc. These information pieces are used by a financial institution not only to manage customers but also to confirm a nominal person or an identity of a person who was actually in charge of deposit contraction etc., in order to prevent money laundering etc. The common account share 204 is an amount within the customer's rights of money retained in a common account managed by the central institution account information 121. The financial institution number 205, the branch number 206, the account number 207, the money amount limit 209, and the priority level 210 are information pieces held for each financial institution in which money of a customer having the customer number 201 is retained and can be held more than one in one customer information table 200. The financial institution number 205 is data that specifies which financial institution is represented by information from the branch number 206 to the priority level 210. The branch number 206 and the account number 207 are data pieces that respectively specify a branch and an account, which branch has accounts, of financial institutions identified by the financial institution number 205, and are set only when the account is already opened.

The pay-in/pay-out permission/non-permission 208 specifies whether the financial management system 110 is permitted to pay in money to the account and pay out money from it, giving “permission” when it is permitted and “non-permission” when it is not permitted.

The money amount limit 209 gives a maximum amount of money that can be distributed to a financial institution specified by the financial institution number 205 when the money management system 110 distributes money. The priority level 210 gives a priority level according to which a financial institution specified by the financial institution number 205 of all financial institutions is selected as a distribution destination when the money management system 110 distributes money, which priority level is supposed to be higher as it has a smaller numeral.

A customer makes a request for the present service from the financial institution A with which he/she transacts business mainly. A request is made at a counter of a financial institution; for example, when a request is sent to the financial institution A system 130, it receives a name, another name (KANA characters), a birth date, an address, a name and a birth date of a representative etc., nominal person's information, a financial institution number of a distribution-destination financial institution, a financial institution number, a branch number, and an account number of an account, if it is opened already, pay-in/pay-out permission/non-permission, and a money amount limit and a priority level for each financial institution of a relevant customer from the input/output device 112 and transmits it as request information to the money management system 110 from the communication device 113. In this case, the customer specifies a financial institution number, a branch number, an account number, a money amount limit, a financial institution number, and a priority level as indispensable information for each of two financial institutions or more and transmits them only to specified financial institutions. The money management system 110, when having received the request information from the financial institution A system 130, newly creates the customer information table 200 and records the received information.

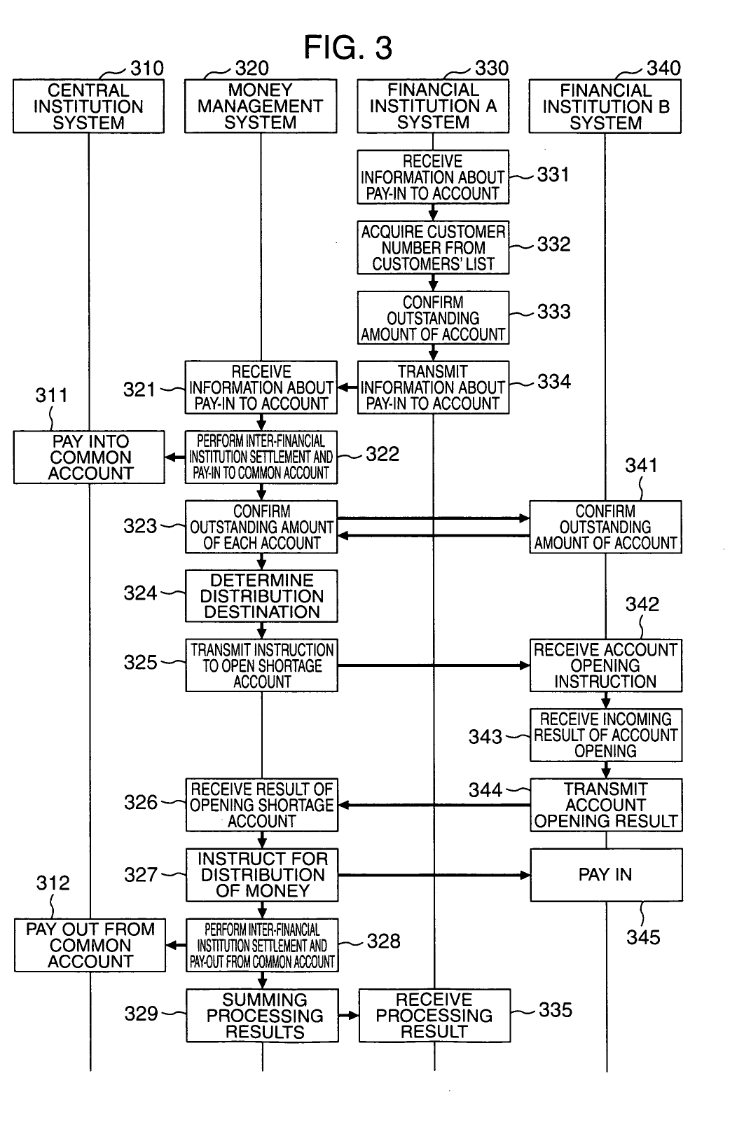

The following will describe a mechanism for pay-in and money distribution by use of a virtual account, with reference to FIG. 3. FIG. 3 shows a processing flow 310 of the central institution system 120, a processing flow 320 of the money management system 110, a processing flow 330 of the financial institution A system 130, and a processing flow 340 of the financial institution B system 141. The following will describe a flow from a moment when money is paid into the financial institution A to a moment when the money is distributed to a financial institution (the financial institution B in this case) other than the financial institution A. This description holds true also with a case where money is paid into any other than the financial institution A, a later-described case where any other than the financial institution B is determined by the money management system 110 to be a distribution destination, or a case where money is to be distributed to a plurality of financial institutions.

The present processing starts when the financial institution A system 130 has received information of pay-in to an account (step 331). The account pay-in information includes information of pay-in from the external terminal 132 of the financial institution A and information of pay-in to a customer's account from any other financial institution transmitted via the network 150, being comprised of a financial institution number of the financial institution A, an account number, and a money amount. When having received pay-in information, the financial institution A system 130 decides whether a pay-in account is a virtual account based on the pay-in information and, if such is the case, obtains the customer number 201 (step 332). This decision is made in accordance with a customers' list held by the financial institution A in the storage device 114. The customers' list is a table for recording correspondence, with the customer number 201, of such customer accounts (virtual accounts) that have subscribed to a service of the present invention of the accounts of the financial institution itself. This customers' list is created by inputting information (account number and customer number 201) from the input/output device 112 when a customer has subscribed to the service. If the customers' list has an account number specified by the pay-in information, the financial institution A system 130 decides that a relevant account is a virtual one for distribution of paid-in money and performs subsequent processing. If the customers' list does not have such an account number, it decides that the account is an ordinary one and suspends processing of the processing flow 330, to perform ordinary pay-in processing.

Next, the financial institution A system 130 uses the financial institution account information 131, to confirm an outstanding amount of an account (virtual account) specified by the pay-in information (step 333). If a sum of the outstanding amount and a money amount specified by the pay-in information is equal to or less than a certain amount, the financial institution a system 130 suspends the processing to perform ordinary pay-in processing. The certain amount refers to, for example, an amount of deposited money protected even if a relevant financial institution has crashed and is set beforehand in the storage device 114 by the input/output device 112 in the financial institution A system 130. If a sum of the outstanding amount and a money amount specified by pay-in information is larger than the certain amount, on the other hand, financial institution A system 130 transmits the pay-in information (financial institution number, account number, and money amount) and the customer number 201 to the money management system 110 via the network 150 (step 334). In this case, the financial institution A system 130 may transmit the pay-in information and the customer 201 to the money management system 110 irrespective of the outstanding amount. This means that no money is retained in the virtual account.

The money management system 110 receives the pay-in information and the customer number 201 (step 321). Hereinafter, the money management system 110 is supposed to perform processing of money on a customer identified by the customer number 201 posted and utilize information of the customer information table 200 identified by the customer number 201.

The money management system 110 notifies the central institution system 120 of pay-in from the financial institution A into a common account and updates the common account share 204 (step 322). This notification contains a financial institution number of the financial institution A and a money amount. Updating of the common account share 204 means to add a received money amount to the common account share 204 of a customer information table 200 identified by the customer number 201. When information is recorded into the common account share 204, a customer identified by the customer number 201 has rights of a money amount of the common account share 204 of money in the common account. Further, inter-financial institution settlement from the financial institution A to the central financial institution is performed.

The central institution system 120, when having received notification of pay-in to the common account, transfers money of a specified money amount to the common account from a financial institution account identified by the financial institution number in an account that the central institution has (step 311). In this case, inter-financial institution money settlement may be performed by the financial institution A system 130 also at step 334. With this, the money paid in by the customer is paid into the common account and, also, a share of the customer is recorded in the common account share 204, thereby completing transfer of the money to the common account.

Next, the money management system 110 confirms an outstanding amount of an account to which the customer's money is to be distributed (step 323). Specifically, the outstanding amount of the account is confirmed by asking one or a plurality of financial institutions about whose financial institution number 205, branch number 206, and account number 207 are registered in a customer information table 200 identified by the received customer number 201. An outstanding amount is confirmed when the money management system 110 transmits the branch number 206 and the account number 207 via the network 150 to a financial institution identified by the financial institution number 205 and, then, the financial institution B system 141 of the transmission-destination financial institution (for example, financial institution B) confirms an outstanding amount of an account based on the financial institution account information 131 and posts it to the money management system 110 (step 341).

Next, the money management system 110 determines distribution destinations of the money (step 324). The distribution destinations are determined by picking up such financial institutions as to be specified as “permitted” by the pay-in/pay-out permission/non-permission 208 in a descending order of the priority level 210 (ascending order of a numeral). First, the money management system 110 stores in the storage device 114 a distribution outstanding amount in a condition where a money amount specified by the pay-in information is set as an initial value. This process is repeated until there is no more distribution outstanding amount.

The money management system 110 checks up to a certain amount of shortage in an outstanding money amount in the financial institution or a shortage up to the money amount limit 209 in an outstanding amount in a financial institution to which the money amount limit 209 is set. Specifically, in a case where a financial institution currently checked by the priority level 210 and identified by the financial institution number 205 is already checked for its outstanding amount at step 323 but yet to have a money amount limit 209 set to it, the system 110 stores in the storage device 114 as a shortage a value obtained by subtracting the outstanding amount from the certain amount. Further, in a case where a financial institution is already checked for its outstanding amount and has a money amount limit 209 registered to it, it stores in the storage device 114 a value obtained by subtracting the money amount limit from the certain amount as a shortage. In the other cases, it stores in the storage device 114 a value obtained by subtracting the money amount limit 209 from the certain amount as a shortage. If a shortage of the certain amount or a shortage of the money amount limit 209 exceeds 0, the money is to be distributed to the financial institution and its money amount is to be distributed to the financial institution (i.e., financial institution identified by the financial institution number 205). Further, if a shortage of the certain amount or a shortage of the money amount limit 209 is not less than a current distribution outstanding amount, the distribution outstanding amount is set as a distribution amount, thereby completing determination of the distribution amount.

If determination of a distribution amount is yet to be completed, the priority level 210 checks a next financial institution in a condition where a value obtained by subtracting from the certain amount a distribution amount calculated from the distribution outstanding amount is set as a new distribution amount.

This process is repeated until there is no more distribution outstanding amount or potential distribution-destination financial institutions (financial institutions which has its financial institution number 205 to priority level 210 registered in the customer information table 200) are all checked. A money amount at a moment when there is no more distribution outstanding amount is determined to be distributed to each of the financial institutions and an outstanding amount of the distribution money amount is added to any distribution destination when the potential distribution-destination financial institutions are all checked. In this case, a post-pay-in outstanding amount exceeds the certain amount. The money management system 110 may distribute an entire amount of outstanding amounts of money amounts to be distributed into one account (for example, an account of a financial institution having a low possibility of crashing) or evenly distribute into the accounts an amount obtained by dividing the outstanding amount of the distribution money amount by the number of accounts of the customer.

Although in the above a pay-in money amount to be determined has been compared to an outstanding amount of each account, the outstanding amount may be that of each financial institution. That is, if a customer has a plurality of accounts in one financial institution (that is, information of the same financial institution number 205 is present as many as two or more in the customer information table 200 of a customer), a total sum of outstanding amounts of the plurality of accounts may be used as the outstanding amount. It is thus possible to avoid an outstanding amount of deposited money from exceeding a certain amount even if customer's money is distributed over a plurality of accounts.

Further, although in the above the priority level 210 has been used to check financial institutions in a sequential order, this order need not strictly be determined for each of customers. For example, the same order may be followed for all of the customers (however, preferably such financial institutions as to have an account already opened in them are given a higher priority level so as to decrease the number of times of opening a new account described later). If, in this case, a distribution-destination financial institution (for example, financial institution B) has no customer's account opened in it, that is, if a branch number 206 or an account number 207 corresponding to the relevant financial institution number 205 in the customer information table 200 is not registered, account opening processing is performed to open an account of the customer in the financial institution B. Although the following will describe a case of opening an account in the financial institution B, any financial institution other than the financial institution B or a plurality of financial institutions may be subject to account opening. Further, if there is no need to open an account, the process goes to step 327.

In the account opening processing, first the money management system 110 transmits as an account opening instruction a name 202 and nominal person information 203 in the customer information table 200 to the financial institution B system 141 (step 325). When having received the account opening instruction (step 342), the financial institution B system 141 displays information contained in the opening instruction on the external terminal 132 installed in a business office, etc. A person in charge in the financial institution B watches the displayed information to open an account of a customer. Next, the external terminal 132 of the financial institution B system receives an incoming account opening result comprised of a branch number and an account number (step 343) and transmits it to the money management system 110 (step 344). When having received the account opening result, the money management system 110 records the received information in the branch number 206 and the account number 207.

The money management system 110 instructs to distribute money in accordance with determined distribution destinations and distribution amounts (step 327). This distribution instruction is executed by transmitting a distributed-money pay-in notification comprised of the account number 207 and the money amount to the financial institution B system of a distribution-destination financial institution (which is supposed to be, for example, financial institution B). When having received the distributed-money pay-in notification, the financial institution B system 141 performs pay-in processing by adding a money amount specified by the financial institution account information 131 to an outstanding amount of an account specified by it (step 345).

The money management system 110 notifies the central financial institution system 120 of pay-in from a common account to each of the distribution-destination financial institutions and updates the common account share 204, to perform inter-financial institution settlement (step 328). This notification contains a financial institution number and a money amount for each of the distribution-destination financial institutions. Here, updating of the common account share 204 means subtraction of a total sum of the money amounts distributed to a common account share 204 in the customer information table 200 identified by the customer number 201. Inter-financial institution settlement means settlement from a financial institution having the common account to a distribution-destination financial institution. Although in the present inter-financial institution settlement an instruction has been given by the money management system 110, it may be executed when the central institution system 120 updates the common account.

Next, the money management system 110 transmits a pay-in history as a processing result to the financial institution A system 130 and stores it in its own storage device 114 (step 329). The financial institution A system 130 stores the pay-in history in the storage device 114 (step 335). The pay-in history comprises a financial institution subject to first pay-in and a paid-in amount for each customer, distribution-destination financial institution and a distributed money amount, a distribution date, and a customer's post-pay-in outstanding money amount (value obtained by adding a paid in money amount to a total sum of outstanding amounts confirmed at step 323). The pay-in history is utilized at the time of inquiry by the customer (details of which are omitted). Now, money paid into the financial institution A has been distributed to the financial institutions registered in the customer information table 200, without exceeding a certain amount or a money amount limit.

Further, in the above flow the paid-in money has been retained in the common account temporarily, to deposit the money in a financial institution having a high reliability during processing taking long time such as account opening, thereby suppressing a risk of losing the money owing to crashing of the financial institution. Therefore, if it is unnecessary to open an account or if the processing can be finished in short time, it may be possible not to use the common account. Specifically, two processing items are eliminated; one processing item of steps 322 and 311 of FIG. 3, for inter-financial institution settlement and pay-in to the common account and the other processing item of steps 328 and 312 for inter-financial institution settlement and pay-out from the common account. Further, at step 327 for money distribution instruction, not only pay-in to a customer's account at a distribution-destination financial institution but also inter-financial institution money settlement from a financial institution to which first pay-in has been made (financial institution A in the present embodiment) to a distribution-destination financial institution (financial institution B in the present embodiment) are performed. In this case, processing after first pay-in to the financial institution A to ending of money distribution can be performed in short time to avoid crashing of the financial institution during the processing or one series of processing items can be performed inseparably to eliminate a risk of losing the money if the financial institution has crashed during distribution. Further, if there is such an account, in the financial institution A to which first pay-in has been made, that its money is protected even upon crashing, the financial institution A system 330 may pay in money to that account in place of the common account.

Another method may be employed for distributing money amount paid in from a customer, by which the pay-in money amount is divided by the number of real accounts of the customer so that each pay-in money amount obtained by the division may be transferred to each of the real accounts of the customer. That is, the money management system 110 calculates the number of real accounts of a customer based on the customer number 201 as referencing the customer information table 200. Then, the money management system 110 divides the pay-in money amount by the number of the real accounts that the customer has. Further, the money management system 110 identifies each real account of the customer based on the customer number 201 as referencing the customer information table 200, to acquire an outstanding amount of each real account of the customer and a certain amount and/or money amount limit. Then, the money management system 110 subtracts the outstanding amount from the certain amount and/or money amount limit for each real account, to calculate a shortage in balance between each pay-in money amount obtained after the division and each real account, thereby deciding whether each pay-in money amount obtained after the division exceeds the shortage in each real account. If it decides that each pay-in money amount does not exceed the shortage, the money management system 110 determines each pay-in money amount obtained after the division to be a money amount to be paid into the real account. If it has decided that each pay-in money amount obtained after the division exceeds the shortage, on the other hand, the money management system 110 calculates a surplus amount and also determines to be a shortage a money amount to be paid into such a real account that each pay-in money amount after the division has exceeded the shortage. Further, the money management system 110 divides the surplus by a numeral obtained by subtracting one from the number of the real accounts of the customer. One is subtracted from that number in order to exclude from the subsequent arithmetic operations such a real account that each pay-in money amount after the division has exceeded the shortage and also that a money amount to be paid into it is already determined. The money management system 110 determines, in much the same as described above, an amount obtained by adding a surplus after the division to each pay-in money amount after the division as each money amount after the division to be paid into a real account other than that for which a pay-in money amount is already determined. This distribution method does not always require a priority level. If a priority level is set, the money management system 110 determines a pay-in money amount starting from the real accounts with higher priority levels and, otherwise, determines a pay-in money amount starting from the real accounts arranged in the customer information table 200. The money management system 110 may alter the priority level dynamically. For example, the money management system 110, when having acquired an outstanding amount, may sort real accounts based on the outstanding amount, to determine priority levels in an ascending or descending order of the outstanding amount. That is, the money management system 110 may determine the priority levels in an ascending or descending order of the shortage.

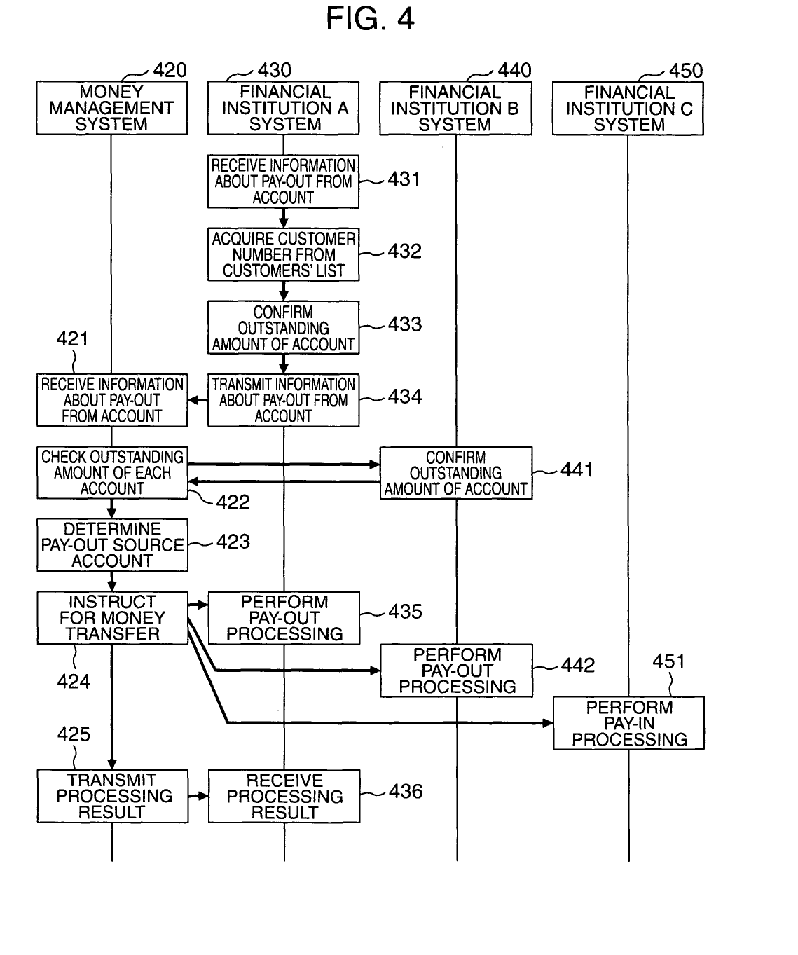

The following will describe a mechanism for pay-out and money concentration by use of a virtual account, with reference to FIG. 4. FIG. 4 shows a processing flow 420 of the money management system 110, a processing flow 430 of the financial institution A system 130, a processing flow 440 of the financial institution B system 141, and a processing flow 450 of the financial institution C system 142. The following will describe a flow in a case where an instruction is issued for pay-out (transmission or transfer) from the financial institution A to the financial institution C. The flow holds true also with the case of pay-in/pay-out for any other financial institutions and a case where the money management system 110 has determined a plurality of financial institutions as a pay-out source as described later. Further, if the financial institutions A and C are the same as each other, the flow refers to that for in-house transfer.

The present processing starts when the financial institution A system 130 has received information of pay-out from an account (step 431). The account pay-out information refers to information of pay-out from the external terminal 132 of the financial institution A or pay-out information transmitted over the network 150, containing a financial institution number and an account number of the financial institution A and a financial institution number and an account number of a pay-out destination financial institution (financial institution C in this case). When having received the pay-out information, the financial institution A system 130 decides whether an account of a pay-out source indicated by the pay-out information has subscribed to a service of the present invention and, if such is the case, acquires a customer number 201 as in the case of step 332 (step 432). Only when an account number specified by the pay-out information is present in a customers' list, the financial institution A system 130 proceeds with the subsequent processing and, otherwise, suspends the processing flow 430, to perform ordinary pay-out processing.

Next, the financial institution A system 130 confirms an outstanding amount of an account specified by the pay-out information as referencing the financial institution account information 131 (step 433). If the outstanding amount is not less than a money amount specified by the pay-out information, the financial institution A system 130 suspends the processing, to perform almost ordinary pay-out processing. If it is less than the money amount specified by the pay-out information, the financial institution A system 130 transmits over the network 150 to the money management system 110 the pay-out information (a financial institution number and an account number of a financial institution having received the pay-out information, a money amount, and a financial institution number and an account number of a pay-out destination) and the customer number 201 (step 434). In this case, the pay-out information and the customer number 201 may be transmitted to the money management system 110 also when the outstanding amount is not less than the money amount specified by the pay-out information.

The money management system 110 receives the pay-out information and the customer number 201 from the financial institution A (step 421). Thereafter, the money management system 110 is supposed to perform money processing on a customer identified by the posted customer number 201 and also utilize information of a customer information table 200 identified by the posted customer number 201.

The money management system 110 confirms an outstanding amount of an account supposed to be a pay-out source of customer's money (step 422). The financial institution B system 141 of a pay-out source financial institution (financial institution B in this example) transmits an outstanding amount to the money management system 110 (step 441). Steps 422 and 441 are the same as steps 323 and 341 respectively, processing of which steps are performed on all financial institutions whose financial institution number 205, branch number 206, and account number 207 are registered.

Next, the money management system 110 determines a money pay-out source and a pay-out money amount (step 423). The pay-out source is determined in the same way as a distribution destination is determined at step 324. However, although financial institutions have been retrieved in a descending order of priority levels until a total sum of margins to a certain amount or a money amount limit reaches a pay-in money amount at step 324, in this example, financial institutions for which the pay-in/pay-out permission/non-permission 208 has come up with “permission” are retrieved in an ascending order of the priority level 210 until a total sum of outstanding amounts reaches a pay-out money amount, thereby determining a pay-out money amount for each account. If even a total sum of all the confirmed outstanding amounts does not reach a money amount specified by the pay-out information, the processing is ended because of insufficiency in outstanding amount.

The money management system 110 instructs money transfer in accordance with the determined pay-out source and a relevant pay-out money amount (step 424). This transfer instruction demands withdrawing of a pay-out money amount from a customer's account to each of financial institutions determined to be the pay-out source at step 423 and pay-in of money to a pay-out destination in accordance with the pay-out information received at step 421. This instruction may be transmitted by the money management system 110 to both of the pay-out source and the pay-out destination or transmitted to the pay-out source together with information of the pay-out destination, asking for transmission of money.

If, in this case, the pay-out source is determined more than one at step 423, money is transmitted to the pay-out destination on more than one occasion. A customer subject to pay-in, who must receive pay-in on one occasion normally, receives pay-in of segmented money amounts on a plurality of occasions, thereby making it difficult to perform correlation (negation) with a request on a sales source (customer of the financial institution A in charge of pay-out in this case). Therefore, the money management system 110 appends identification data (a numeral to enable combining a plurality of transfer operations or information of pay-out from the pay-out source (name 203 of the pay-out source, etc.)) to an instruction to be transmitted to the pay-out source or destination. If the identification data is appended, the pay-out destination financial institution C system 142 performs pay-in only on one occasion by handling as one pay-in data item a notification of a plurality of pay-in occasions transmitted from the money management system 110 or the plurality of pay-out source financial institutions or, even if performing individual pay-in operations, describes the identification data in pay-in particulars (containing description into passbook, display on a screen in a firm banking system) to be presented to the customer.

Next, the money management system 110 transmits a pay-out history as a processing result to the financial institution A system 130 and also stores it in the storage device 114 of the money management system 110 (step 425). The financial institution A system 130 stores the pay-out history in the storage device 114 (step 436). The pay-out history comprises a financial institution having received the pay-out information first for each customer, pay-out source financial institutions and their respective pay-out money amounts, dates, and a customer's post-pay-out outstanding money amount (value obtained by subtracting a paid-out money amount from a total sum of outstanding amounts confirmed at step 433). The pay-out history is utilized at the time of inquiry by the customer (details of which are described later).

By the above processing, when an instruction is issued by a customer to transfer (transmit) money from a certain account (account in the financial institution A in this example) to another account (financial institution C in this example) and even if the account in the financial institution A is insufficient in outstanding amount, this transfer can be performed by collecting money from an account (account in the financial institution B in this example) in at least one of other financial institutions.

Further, although in the above example the money management system 110 has issued an instruction for pay-out and pay-in, a transfer instruction containing information of the pay-in destination and identification data may be transmitted to the pay-out source, to permit a money collection source to transmit money and the identification data to the pay-in destination.

Further, although the above example has been described in a case where a customer has instructed to transfer money from the financial institution A to the financial institution C, withdrawal of money in the financial institution A may not be accompanied by pay-in to the financial institution C. This holds true with, for example, a case where a customer withdraws money in cash.

In the above processing of pay-in sown in FIG. 3 and pay-out shown in FIG. 4, an outstanding amount of an account to which a customer directly gives a pay-in or pay-out instruction need not be managed by the financial institution account information 131 of the financial institution A system 130. That is, by the present method, an account number is utilized only as a pay-in/pay-out counter, to retain actual money in another account. This is realized by keeping the outstanding amount to zero always so that the pay-in/pay-out permission/non-permission may come up with “non-permission”.

The above has described processes for pay-out from a virtual account with reference to FIG. 4 and pay-in to it with reference to FIG. 3. A problem of the case of utilizing the method described is that each time a customer pays in or pays out money, actually a pay-in or pay-out operation occurs on a plurality of occasions, to increase costs. Inter-financial institution settlement, in particular, requires a high-cost commission as compared to transfer in the same financial institution. Therefore, an account selection method is described below which decreases the number of times of inter-financial institution settlement. First, in determination of a pay-out source at step 423, prior to checking in an order of the priority level 210, if an account of a pay-out destination financial institution indicated by pay-out information received at step 421 is present in the customer information table 200, the accounts are checked preferentially irrespective of the priority level 210, so that any one of them that is capable of pay-out is determined to be a pay-out source account. In such a manner, transfer in the same financial institution is performed preferentially if the same financial institution as that of an account supposed to be a pay-out source has an account of a pay-out source customer.

Further, although a pay-out source and a distribution destination may be determined in the same way as in the cases of steps 423 and 324, respectively, if a pay-out destination due to the pay-out information received at step 421 has been registered in any customer information table 200 of the customer information DB115, transfer can be performed from one virtual account to another (without using a common account) by determining a pay-in destination at step 424 in the same way as in the case of step 324. In this case, preferably the pay-out source and the distribution destination may be the same financial institution as much as possible in order to suppress inter-financial institution settlement. A method of determining the pay-out source and the distribution destination is described below with reference to FIG. 5. FIG. 5 shows an example of an account 510 of a customer who wishes to pay out money and an account 520 of a customer who is to receive the money. In FIG. 5, the pay-out source customer has his/her accounts in financial institutions X511, Y512, and Z513, while the pay-out destination customer has his/her accounts in financial institutions Y521, Z522, and W523. In such a case that the pay-out source customer and the pay-out destination customer have a common financial institution (financial institutions Y and Z in the figure) where they have their respective accounts, these common financial institutions are selected preferentially. Specifically, the money management system 110 retrieves pay-out sources about financial institutions common to the pay-out destination before determining the pay-out source in an order of the priority level 210 at step 423. In determination of a distribution destination at step 324, the money management system 110 checks the common financial institutions as a distribution destination preferentially. With this, it is possible to perform transfer in the same financial institution preferentially as in the case of transfers 531 and 532.

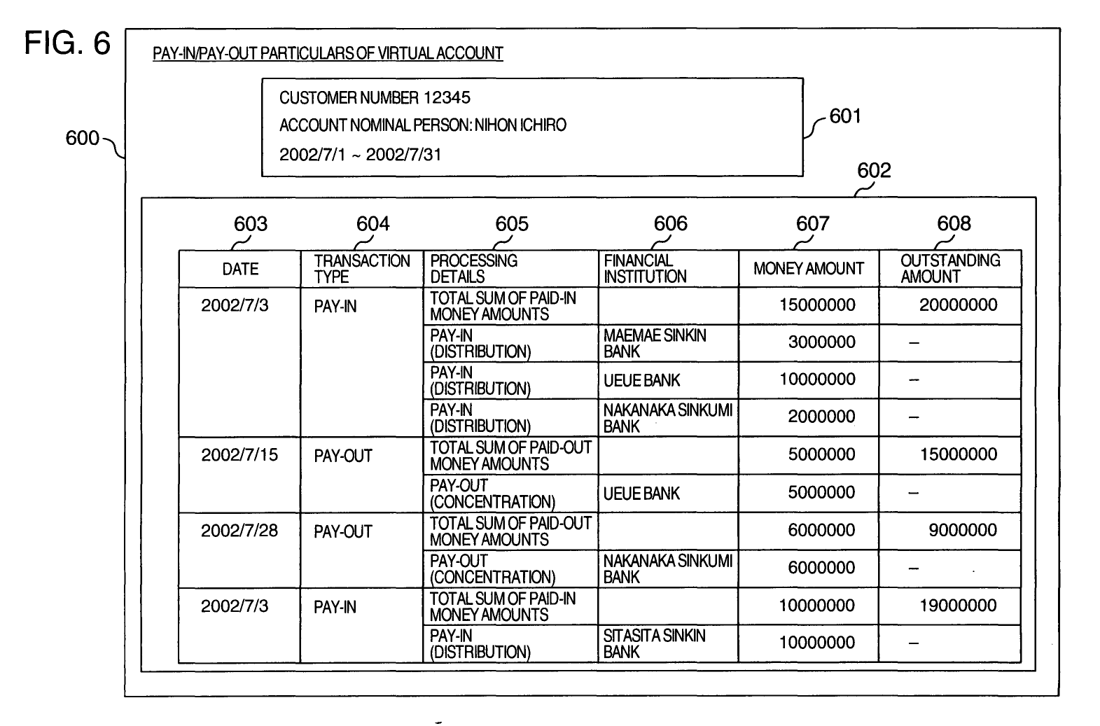

The following will describe pay-in/pay-out particulars of customer's money with respect to FIG. 6. A customer needs to confirm his/her own transaction later in some cases. In such a case, a particulars output system utilized by the customer (external terminal 132, a transaction terminal (not shown) connected to the network 150 independently of financial institutions, etc.) receives a pay-in history or a pay-out history of the money management system 110 or the financial institution A system 130 (as in the case of any other financial institutions) and displays or prints pay-in/pay-out particulars 600. In this case, the money management system 110 or the financial institution A system 130 responds to a request from a transaction terminal utilized by the customer, to transmit the pay-in history and the pay-out history. Contents of the pay-in/pay-out particulars 600 are organized from the pay-in and pay-out histories and displayed by the money management system 110 or the financial institution A system 130 or the external terminal 132 or the transaction terminal.

The pay-in/pay-out particulars 600 comprise the following. A customer information portion 601 constitutes information of a customer corresponding to the pay-in/pay-out particulars 600 and is acquired from the customer information DB115 of the money management system 110 or the financial institution account information 131 of the financial institution A system 130. A particulars portion 602 is created from a pay-in history and a pay-out history stored in the storage device 114 by the money management system 110 or the financial institution A system 130, to record details of a transaction of the customer, being comprised of a date 603, a transaction type 604, processing details 605, a financial institution 606, a money amount 607, and an outstanding amount 608. The date 603 indicates a day on which a transaction indicated by the information was performed. The transaction type 604 indicates a type of either pay-in or pay-out. The processing details 605 indicate how a transaction indicated by the transaction type 604 was actually performed, to show a type of a total sum of money amounts paid-in to or paid-out from the financial institution, pay-in (distribution) from the financial institution to any other financial institution as involved in pay-in to the financial institution, or pay-out (concentration) from any other financial institution as involved in pay-out from the financial institution. The financial institution 606 indicates on an account of which financial institution the processing details 605 were performed. The money amount 607 indicates a money amount paid in or paid out as indicated by the processing details 605. The outstanding amount 608 indicates an outstanding amount of money of the customer that is left after pay-in or pay-out processing.

The outstanding amount of each financial institution may be enquired by the money management system 110 to the financial institution system each time the customer makes an inquiry about paid-in or paid-out money amount or an outstanding amount or, instead of enquiring to the financial institution system, be stored and managed by the money management system 110. Further, a common account and a virtual account need not be provided. That is, a virtual or real account may be used in place of a common account or a common or real account may be used in place of a virtual account. Further, functions of the money management system 110 may be provided to the financial institution system.

Further, in a case where a customer has requested pay-in, the pay-in operation may be performed preferentially on a real account of a financial institution system that received the pay-in request within a predetermined amount. Further, in a case where a customer has requested pay-out, the pay-out operation may be performed preferentially on a real account not of a financial institution that has received the pay-out request. It is thus possible to avoid money of a customer from being decreased in a financial institution that has received a pay-in or pay-out request from the customer.

By the embodiments of the present invention, it is possible to suppress a risk of a customer losing his/her money owing to crashing of a financial institution. Money, if paid into one account in a financial institution, can be distributed to a plurality of other financial institutions, to minimize a risk of losing the money if the financial institution has crashed. It is thus possible for a customer to use one account as a virtual account for use in pay-in and pay-out only, in order to automatically distribute his/her money to a plurality of financial institutions so that he/she can concentrate his/her money from the plurality of financial institutions, thus facilitating a transaction. Further, the present invention makes it possible for a user to easily confirm particulars of a transaction by use of a virtual account.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A method for managing money of a customer who has an account in a plurality of financial institutions, comprising the steps of:
(a) storing in a storage device information about a predetermined money amount for said account, individual information of said customer, and information about said account in each of said financial institutions where said customer has said account;
(b) receiving information about pay-in from said customer;
(c) identifying said account in each of said financial institutions where said customer has said account, based on said information about said account of said customer in each of said financial institutions;
(d) enquiring to each of said financial institutions where said customer has said account, to receive information about an outstanding amount of said account in each of said financial institutions;
(e) identifying said outstanding amount of said account in each of said financial institutions based on said information about said outstanding amount, to determine a distribution pay-in money amount to be distributed to said account in each of said financial institutions in such a manner that a post-pay-in outstanding amount obtained by adding said pay-in money amount to said outstanding amount of said account may not exceed said predetermined money amount; and
(f) instructing to pay said determined distribution pay-in money amount for said account in each of said financial institutions.

2. The method according to claim 1, further comprising the steps of:
(g) paying said pay-in money amount into a common account that can retain money of a plurality of customers,
wherein said step (f) instructs to transfer said pay-in money amount from said common account to said account in each of said financial institutions.

3. The method according to claim 1, further comprising the steps of:
(g) identifying a financial institution where said customer has opened no account from a list stored in said storage device and said information about said account of each of said financial institution where said customer has said account, to transmit said individual information of said customer to said financial institution where said customer has opened no account and also request to open an account of said customer;
(h) receiving from said financial institution said information about said opened account of said customer; and
(i) additionally writing said received information about said account of said customer into said information about said account of said customer in said storage device.

4. The method according to claim 1, further comprising the steps of:
(g) paying said pay-in money amount into a virtual account assigned to each customer,
wherein said step (f) instructs to transfer said pay-in money amount from said virtual account to said account in each of said financial institutions.

5. The method according to claim 1, wherein said step (e) further comprises the steps of:
(g) subtracting said outstanding amount of said account from said predetermined amount, to calculate a shortage for each of said accounts in each of said financial institutions;
(h) deciding whether said pay-in money amount exceeds said shortage for each of said accounts in each of said financial institutions;
(i) if it is decided that said pay-in money amount does not exceed said shortage, determining said pay-in money amount to be a distribution pay-in money amount for said account;
(j) if it is decided that said pay-in money amount exceeds said shortage, determining said shortage to be said distribution pay-in money amount for said account; and
(k) if it is decided that said pay-in money amount exceeds said shortage, determining an amount obtained by subtracting said shortage from said pay-in money amount to be said pay-in money amount, to repeat from said step (h) to said step (i) on accounts other than said account for which said pay-in money amount is determined.

6. The method according to claim 5, wherein said step (e) determines said distribution pay-in money amount for said accounts in a descending order of said shortage.

7. The method according to claim 5, wherein if said pay-in money amount has a surplus as a result of determining said distribution pay-in money amount for all accounts of said customer, said step (e) adds said pay-in money amount surplus to said distribution pay-in money amount for an account in a financial institution having a smaller possibility of crashing.

8. The method according to claim 5, wherein if said pay-in money amount has a surplus as a result of determining said distribution pay-in money amount for all accounts of said customer, said step (e) divides said pay-in money amount surplus by the number of said accounts of said customer and adds an amount obtained by said division to said distribution pay-in money amount for each of said accounts.

9. A system for managing money of a customer who has an account in a plurality of financial institutions, comprising:
a storage device for storing information about a predetermined money amount for said account, individual information of said customer, and information about said account in each of said financial institutions where said customer has said account;
a reception processing portion for receiving information about pay-in from said customer;
an account identification processing portion for identifying said account in each of said financial institutions where said customer has said account, based on said information about said account in each of said financial institutions where said customer has said account;
an outstanding amount confirmation processing portion for enquiring to each of said financial institutions where said customer has said account, to receive information about an outstanding amount of said account in each of said financial institutions;
a distribution processing portion for identifying said outstanding amount of said account in each of said financial institutions based on said information about said outstanding amount, to determine a distribution pay-in money amount to be distributed to said account in each of said financial institutions in such a manner that a post-pay-in outstanding amount obtained by adding said pay-in money amount to said outstanding amount of said account may not exceed said predetermined amount; and
an instruction processing portion for instructing to pay said distribution pay-in money amount into said account in each of said financial institutions.

10. The system according to claim 9, wherein said predetermined money amount should be secured by a “pay-off” system.

11. A method for processing pay-in from a customer who has an account in a plurality of financial institutions, comprising the steps of:
(a) receiving information about pay-in to said account in said financial institutions;
(b) deciding whether said customer is registered as a person who distributes a pay-in money amount for one financial institution to said plurality of financial institutions;
(c) if said customer is registered as said person who distributes said pay-in money amount for said one financial institution to said plurality of financial institutions, transmitting said information about said pay-in to a money management system which manages said account of said customer in said plurality of financial institutions;
(d) receiving from said money management system a request for transmission of a pay-in money amount identified by said information about said pay-in, identification information of other money-transmission destination financial institutions, and information about said account of said customer in said other financial institutions; and
(e) transmitting said money to said other financial institutions based on said identification information of said other financial institutions and said information about said account of said customer in said other financial institutions.

12. The method according to claim 11, further comprising the steps of:
(f) storing in a storage device information about an amount predetermined for said account; and
(g) deciding whether a post-pay-in outstanding amount obtained by adding said pay-in money amount to an outstanding amount of said account of said customer in said financial institution exceeds said predetermined amount,
wherein if it is decided that said post-pay-in outstanding amount exceeds said predetermined amount, said step (c) transmits to said money management system said information about said pay-in or information containing a money amount obtained by subtracting said predetermined amount from said post-pay-in outstanding amount in place of said pay-in amount, as said information about said pay-in.

13. The method according to claim 11, wherein said step (c) transmits said information about said pay-in to said money management system and also transmits said pay-in money amount to a management system that manages a common account capable of retaining money of a plurality of customers.

14. The method according to claim 11, further comprising the steps of:
(f) storing individual information of said customer in a storage device;
(g) receiving said individual information of said customer and a request for opening an account from said money management system;
(h) opening said account of said customer based on said individual information of said customer received; and
(i) transmitting information about said opened account to said money management system.

15. The method according to claim 11, wherein said step (b) decides whether an account identified by said information about said pay-in is a virtual account, to thus decide whether said customer is registered as a person who distributes pay-in money for one financial institution to a plurality of financial institutions.

16. A system for processing pay-in from a customer who has an account in a plurality of financial institutions, comprising:
a reception processing portion for receiving information about pay-in to said account;
a decision processing portion for deciding whether said customer is registered as a person who distributes pay-in money for one financial institution to a plurality of financial institutions;
a transmission processing portion for transmitting said information about said pay-in to a money management system who manages said account of said customer in said plurality of financial institutions if said customer is registered as said person who distributes said pay-in money for said one financial institution to said plurality of financial institutions;
a reception processing portion for receiving from said money management system a request for transmission of a pay-in money amount identified by said information about said pay-in, identification information of other money-transmission destination financial institutions, and information about accounts of said customer in said other financial institutions; and
a money-transmission processing portion for transmitting said pay-in money amount to said other financial institutions based on said identification information of said other financial institutions and said information about said account of said customer in said other financial institutions.

17. A method for managing money of a customer who has an account in a plurality of financial institutions, comprising the steps of:
(a) storing in a storage device information about an account in each financial institution for each of said customers;
(b) receiving information about pay-out requested by said customer, from a financial institution to which said customer makes a pay-out request;
(c) identifying each of said financial institutions where said customer has said account, based on said information about said account;
(d) requesting each of said identified financial institutions to give information about an outstanding amount of said account of said customer;
(e) receiving said information about said outstanding amount from each of said financial institutions;
(f) determining an individual pay-out money amount to be paid out from each of said financial institutions based on said information about said outstanding amount, in such a manner that a total sum of said individual pay-out money amounts to be paid out from said financial institutions may become a pay-out money amount identified by said information about said pay-out; and
(g) instructing each of said financial institutions to transfer said determined individual pay-out money amount from said account in each of said financial institutions to a financial institution to which said customer makes a pay-out request and also transmitting to each of said financial institutions identification information indicating that said pay-out is based on said information about said pay-out.

18. A method for processing pay-in to a pay-out destination customer from a pay-out source customer who has an account in a plurality of financial institutions, comprising the steps of:
(a) receiving an instruction for pay-in to said account of said pay-out destination customer in a financial institution for said accounts in a plurality of other financial institutions where said pay-out source customer has said account and identification information indicating that said pay-in instruction is of pay-in based on information about one pay-in operation by said pay-out source customer; and
(b) if said identification information indicates certain pay-in instructions, adding together pay-in money amounts due to said plurality of pay-in instructions identified by said identification information to provide a total sum and then paying said total sum money amount into said account of said customer of said pay-out destination customer in said financial institution on one occasion.

19. A method for managing money of a customer who has an account in a plurality of financial institutions, comprising the steps of:
(a) receiving information about transfer between at least one customer account in a pay-out source financial institution and at least one customer account in a pay-out destination; and
(b) if there is said financial institution which is common to at least one financial institution where said pay-out source customer has said account and at least one financial institution where said pay-out destination customer has an account, instructing transfer of money from said customer account of said pay-out source in said common financial institution to said customer account of said pay-out destination within predetermined respective amount limit ranges of a pay-out source outstanding amount and a pay-out destination outstanding amount preferentially over transfer of money from said customer account of said pay-out source to said customer account of said pay-out destination between said different financial institutions.

20. A method for outputting transaction particulars about a transaction between a customer and a financial institution from an output device, comprising the steps of:
(a) outputting from said output device a total sum money amount of individual money amounts paid into or paid out from said financial institution for each of said customers; and
(b) for a purpose of distribution or concentration of said total sum money amount determined by a money management system that manages accounts of said customer in a plurality of financial institutions, outputting from said output device a name of said financial institution and said distributed or concentrated money amount for each of said financial institutions.
